(19) United States
(12) Patent Application Publication
(10) Pub. No.: US 2025/0109312 A1
(43) Pub. Date: Apr. 3, 2025

(54) Stable Hybrid Formulations of Acrylic Emulsion and Polyurethane Dispersions and Applications Thereof

(71) Applicant: Henry Company, LLC, Kimberton, PA (US)

(72) Inventor: Zhiyong Zhu, Chadds Ford, PA (US)

(21) Appl. No.: 18/904,885

(22) Filed: Oct. 2, 2024

Related U.S. Application Data
(60) Provisional application No. 63/587,159, filed on Oct. 2, 2023.

(51) Int. Cl. C09D 133/04; C08K 3/22; C09D 5/02; C09D 7/61; C09D 7/80

(52) U.S. Cl. CPC C09D 133/04; C08K 3/22; C09D 5/022; C09D 7/61; C09D 7/80; C08K 2003/2206; C08K 2003/2241

(57) ABSTRACT

This invention relates to the roofing, waterproofing, and building envelope industries. Disclosed herein are hybrid compositions of acrylic emulsion and polyurethane dispersion for coating roofs, facades, floors or vertical facings. The compositions combine the advantages of the excellent features of polyurethane compositions with the reduced cost of acrylic compositions in such a manner that a balance between both characteristics is shown. Also disclosed are methods for covering a roof, facade, floor or vertical facing with these compositions and the use thereof as a coating for roofs, facades, floors or vertical facings.

### FIELD OF INVENTION

This invention relates to the roofing, waterproofing, and building envelope industries. Disclosed herein are hybrid compositions of acrylic emulsion and polyurethane dispersion for coating roofs, facades, floors or vertical facings. The compositions combine the advantages of the excellent features of polyurethane compositions with the reduced cost of acrylic compositions in such a manner that a balance between both characteristics is shown. Also disclosed are methods for covering a roof, facade, floor, or vertical facing with these compositions and the use thereof as a coating for roofs, facades, floors, or vertical facings.

### BACKGROUND

Aqueous acrylic or polyurethane dispersions have been widely used in coating applications. But if they are combined, the properties of these mixtures do not achieve the aforementioned properties from the traditional “rule of mixtures”. The non-homogeneity caused by the different acrylic and polyurethane domains likely contribute to these effects. These areas can have excessive internal stress and/or incomplete coalescence, which can cause an increased permeability and reduced bond strength.

For example, U.S. Patent Application Publication No. 2001/0007711 A1 describes a method for coating concrete molds comprising the application of at least one plastic mineral composition which can bond to cement, comprising at least one aqueous polymer dispersion containing a percentage not exceeding 2% by weight of copolymerized monoethylenically unsaturated monomers.

International Publication No. WO 96/00259 describes a method for producing a thermosetting elastomeric matrix, comprising vulcanizing an elastomeric material and a thermoplastic polymer material having a predetermined softening/melting temperature, producing a dispersion of the thermoplastic polymer material through the vulcanizable elastomeric material, and finally curing the thermoplastic-containing matrix.

U.S. Patent Application Publication No. 2005/0124736 A1 describes aqueous polymer compositions containing at least one aqueous bitumen dispersion and at least one aqueous dispersion of at least one polyurethane. This composition is used in surface dressings and as watertight roof coatings.

U.S. Pat. No. 4,331,726 describes pourable roofing compositions comprising discrete small chunks or pieces of closed cell plastics material, such as polyurethane, an inert particulate material, and an emulsion caulking or sealing type binder or adhesive based on acetates, acrylic resins, epoxy adhesives, and the like.

U.S. Pat. No. 8,536,263B2, on the other hand, combines the acrylic polymer and the polyurethane, but only in presence of a third component, ethylene vinyl acetate emulsion, added in a significant measure to achieve the elusive homogeneity or stability.

The present invention addresses the above problems of stability and homogeneity in an aqueous hybrid of acrylic polymer and a polyurethane dispersion, but without the facilitation by the third component, i.e., ethylene vinyl acetate emulsion of the U.S. Pat. No. 8,536,263B2 reference, or for that matter, any other stabilizing agent or a dispersion agent such as a surfactant.

### SUMMARY OF INVENTION

The present invention improves the performance of traditional acrylics emulsions, to pass a critical waterproofing standard, in order to be used, inter alia, in applications that have harsher environment. The inventions achieved a better performance and cost efficiency and one that can pass the stringent and critical waterproofing standards, for example, of ASTM D7281.

This invention involves the inclusion of polyurethane dispersions (PUD) into a typical acrylics coating formula, to create a compatible liquid system, to meet critical waterproofing application requirements. The new liquid system can be used as a coating or a sealant, to meet ASTM D7281, a critical waterproofing standard, which cannot be achieved by the acrylics system alone.

In one embodiment, this invention relates to an aqueous composition suitable for coating roofs, facades, floors or vertical facings, comprising:
i) an acrylic polymer emulsion, and
ii) an aqueous polyurethane polymer dispersion.

In another embodiment, this invention relates to the composition as recited above, wherein the acrylic polymer and polyurethane polymer is in the form of a combined product of the acrylic polymer with on the polyurethane polymer, wherein the polyurethane polymer is a polyether-based or polyester-based polyurethane.

In yet another embodiment, this invention relates to a composition as recited above, wherein in the combined product of at least one acrylic polymer with at least one polyurethane polymer, the polyurethane polymer is in a proportion between 5 and 85% by weight of the weight of the combined product.

In yet another embodiment, this invention relates to a composition as recited above, wherein in the combined product of at least one acrylic polymer emulsion with at least one polyurethane polymer dispersion, the acrylic polymer emulsion is in a proportion between 5 and 85% by weight of the weight of the combined product.

In yet another embodiment, this invention relates to a composition as recited above, wherein in the combined product of the acrylic polymer with the polyurethane polymer, the polyurethane polymer is in a proportion between 10 and 50% by weight of the weight of the combined product.

In yet another embodiment, this invention relates to a composition as recited above, wherein the combined product of the acrylic polymer with the polyurethane polymer is at a concentration between 30 and 40% by weight of the total weight of the composition.

In yet another embodiment, this invention relates to a composition as recited above, wherein, the polyurethan polymer is in the range of 5% to 25% of the total weight of the aqueous composition.

In yet another embodiment, this invention relates to a composition as recited above, wherein the acrylic polymer is a thermoplastic, non-styrenic polymer in an external aqueous emulsion.

In yet another embodiment, this invention relates to a composition as recited above, wherein the polyurethane polymer is an aliphatic polymer in aqueous solution or dispersion.

In yet another embodiment, this invention relates to a composition as recited above, wherein the water content is between 10 and 40% by weight of the total weight of the composition.

In yet another embodiment, this invention relates to a composition as recited above, further comprising a UV stabilizer.

In yet another embodiment, this invention relates to a composition as recited above, comprising an aqueous PUD in the amount of 10% of the total weight of the aqueous composition.

In yet another embodiment, this invention relates to a composition as recited above, wherein the acrylic emulsion content is about 35% of the total weight of the aqueous composition.

In yet another embodiment, this invention relates to a composition as recited above, wherein said composition comprises at least one of a UV stabilizer, rheological additives, preservatives, bactericidal agents, de-airing agents, water repellant agents, filler wetting agents, fillers and pigments, and combinations thereof.

In yet another embodiment, this invention relates to a method for covering a roof, facade, floor or vertical facing with a composition, the method comprising:
a) stirring the composition as recited above by mechanical stirring until achieving complete homogeneity thereof; and
b) applying the composition resulting from step a) on a roof, facade, floor, or vertical facing with a roller, brush, trowel or by spraying.

In yet another embodiment, this invention relates to a method as recited above, further comprising:
c) applying the composition resulting from step a) on a dry layer obtained by step b) by means of a roller, brush, trowel or by spraying.

In yet another embodiment, this invention relates to a method as recited above, further comprising incorporating a polyester mesh in the entirety of the coating surface or in individual points thereof.

In yet another embodiment, this invention relates to a method of applying a composition to a substrate, the method comprising:
a) stirring the composition according to those recited above; and
b) applying the composition resulting from the step a) on a substrate.

In yet another embodiment, this invention relates to a method as recited above, wherein in step a), the stirring is conducted by mechanical stirring.

In yet another embodiment, this invention relates to a method as recited above, wherein step a) is effective to achieve complete homogeneity of the stirred composition.

In yet another embodiment, this invention relates to a method as recited above, wherein in step b), the composition is applied with a roller, brush, trowel or by spraying.

In yet another embodiment, this invention relates to a roof, facade, floor or vertical facing, comprising an aqueous composition, wherein the aqueous composition comprises:
i) at least one acrylic polymer,
ii) at least one polyurethane polymer as recited in claims above.

In one embodiment, this invention relates to a process of preparing the composition as recited above, comprising controlling the pH and viscosity to stabilize the composition of PUD and acrylic emulsion.

### BRIEF DESCRIPTION OF THE DRAWINGS

FIG. 1 depicts the ASTM 7281 test apparatus in the first picture. The second picture is the experimental sample E1, which showed no leakage. In the third picture is shown the control C1, which failed and was leaking.

FIG. 2 depicts the experimental sample on the sample on left that comprises the blend of polyurethane dispersion and the acrylic emulsion. The sample on the right is the control sample C1. This was when the samples were freshly applied.

FIG. 3 shows the experimental sample E1 with a UV stabilizer demonstrating a significant improvement. The sample on the left is C1. The sample in center is E1, and the one on the right is E1 plus a UV stabilizer.

FIG. 4 shows the experimental sample E1 on the left that showed partial cohesive failure at 2.0 pli. The sample on the right is the control sample C1, which showed complete adhesive failure at 1.1 pli.

FIG. 5 shows the chart of viscosity as function of aging for the L-2357 PU which tends to gel and the present composition, which is a two-component blend.

FIG. 6 shows the aging days at room temperature and how viscosity is impacted by it for the L-2357 as well as the Experimental E1 sample.

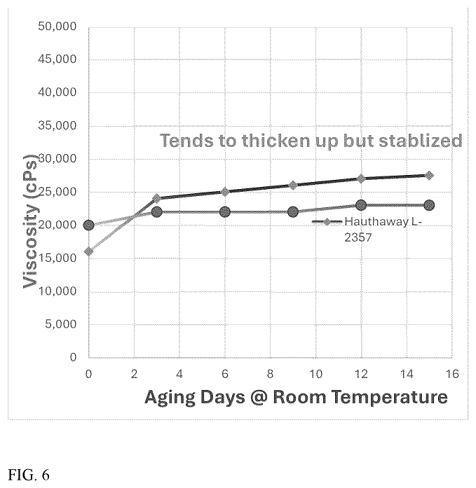

FIG. 7 relates to two sets of blend samples, PU1 and PU2 without and with UV stabilizer, respectively, and with varying percent of acrylic emulsion and polyurethane dispersion.

### DETAILED DESCRIPTION OF THE EXEMPLARY EMBODIMENTS

Before the present compositions, articles, devices, and/or methods are disclosed and described, it is to be understood that the aspects described below are not limited to specific methods as such may, of course, vary. It is also to be understood that the terminology used herein is for the purpose of describing particular aspects only and is not intended to be limiting. As used in the specification and in the claims, the term “comprising” may include the embodiments “consisting of” and “consisting essentially of.”

Disclosed are materials, compositions, and components that can be used for, can be used in conjunction with, can be used in preparation for, or are products of the disclosed method and compositions. These and other materials are disclosed herein, and it is understood that when combinations, subsets, interactions, groups, and the like of these materials are disclosed that while specific reference of each various individual and collective combinations and permutation of these compounds cannot be explicitly disclosed, each is specifically contemplated and described herein. Thus, if a class of adhesives A, B, and C are disclosed as well as a class of additives D, E, and F and an example of a combination A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D.

This concept applies to all aspects of this disclosure including, but not limited to, compositions, and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Unless expressly stated otherwise, it is not intended that any method outlined herein be construed as requiring that its steps be performed in a particular order. Accordingly, where a method claim does not expressly recite an order to be followed by its steps, or where neither the claims nor the descriptions specifically state that the steps are to be limited to a precise sequence, it should not be inferred that a specific order is intended or required. This holds for any possible non-express basis for interpretation, including but not limited to: logical flow or arrangement of steps; interpretations derived from the grammatical organization, syntax, or punctuation; and the quantity or variety of embodiments detailed in the specification. The description of the invention should not be read as mandating a fixed sequence of steps, unless such a requirement is articulated explicitly.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range.

It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an endpoint of a range, the disclosure should be understood to include the specific value or endpoint referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise. As used in the specification and the appended claims, the singular forms “a,” “an,” and “the” include plural referents unless the context clearly dictates otherwise.

The term “predominant portion” or “predominantly”, as used herein, unless otherwise defined herein, means greater than 50% of the referenced material.

If not specified, the percent is on a molar basis when reference is made to a molecule (such as hydrogen and ethylene), and otherwise is on a weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

All parts, percentages and ratios used herein are expressed by weight unless otherwise specified.

In this specification and in the claims which follow, reference will be made to a number of terms which shall be defined herein.

“Optional” or “optionally” means that the subsequently described event or circumstance can or cannot occur, and that the description includes instances where the event or circumstance occurs and instances where it does not.

While aspects of the present invention can be described and claimed in a particular statutory class, such as the system statutory class, this is for convenience only and one of skill in the art will understand that each aspect of the present invention can be described and claimed in any statutory class.

Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification. Throughout this application, various publications are referenced. The disclosures of these publications in their entireties are hereby incorporated by reference into this application in order to more fully describe the state of the art to which they pertain. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation. In the context of the present description, all publications, patent applications, patents and other references mentioned herein, if not otherwise indicated, are explicitly incorporated by reference herein in their entirety for all purposes as if fully set forth.

The following describes exemplary embodiments of the present invention in the building construction context-coating roofs, facades, floors or vertical facings.

Generally speaking and in one embodiment, this invention relates to an aqueous composition suitable for coating roofs, facades, floors or vertical facings, comprising an acrylic polymer emulsion and a polyurethane dispersion (PUD).

The selection of PUD and acrylics emulsion, and their blending ratios are specifically defined to provide compatibility and a final product that performs as defined infra.

According to an exemplary aspect, provided is a composition which can be used as a liquid membrane for coating roofs, which is able to combine the advantages of the excellent features of polyurethane compositions with the reduced cost of acrylic compositions, showing a balance between both characteristics, for coating roofs and facades. Further in accordance with exemplary aspects, provided are aqueous compositions for coatings, for example, for outdoor coatings, such as coatings for roofs, showing a balance between the advantages of the better features of polyurethane and the reduced cost of acrylic.

For example, it is possible to achieve a polyurethane-acrylic composition by means of the combination of
i) a polyurethane dispersion and
ii) an emulsion from an acrylic component.

The properties of acrylic coatings versus the polyurethane coatings are given below:

| | | Polyurethane |
|---|---|---|
| Characteristics | Acrylic Coatings | Coatings |
| Mechanical Strength | Low | High |
| Abrasion and Impact | High | High |
| Strength | | |
| Adhesion to Substrates | Low | High |
| Water-proofing | Good | Better |
| Resistance to Chemicals | Moderate | Better |
| Parts | Typical 1 Part | Typica 2Parts |
| UV Exposure | Stable | Might Yellow |
| Bio-growth Resistance | Good | Poor |

In one embodiment, the acrylic emulsion and the water-based polyurethane dispersion are physically admixed, and in order to keep the blend to be “homogeneous” and “stable”, we found adjusting the viscosity and pH can improve the stability of the blend. No additional surfactant was added. There is a concern that the surfactant in acrylic emulsion and in PUD, when they are mixed, may not be compatible and may be unstable.

In the present specification, an emulsion from an “acrylic component” is understood as an emulsion, preferably aqueous, of any acrylic acid derivative, for example, non-styrenic, although it could also be styrenic. “Acrylate” is understood as any acrylic acid derivative, polyacrylates, methacrylic acid or polymethacrylates.

### Aqueous Polyurethane Dispersions

Also, in the present specification, “polyurethane dispersion” is understood as any aqueous dispersion of a polymer composition consisting of chains of organic units bound by urethane bonds, and which can be obtained by means of the condensation of polyols or polyesters with polyisocyanates. For example, the polyurethane component does not have any free isocyanate groups left. In one embodiment, the PUD is a branched, aliphatic, polyether-based dispersion, for example, the Hauthane L-2357 and other series of dispersions from C. L. Hauthaway & Sons, Corp., Mass. In another embodiment, the PUD is an anionic aliphatic polyester-polyurethane dispersion, for example, the Bayhydrol® UH 2864 and such series of polyurethanes.

A preferred urethane resin to be used as dispersion is a polyester resin including a structural unit containing a urethane bond. Among such resins, a water-soluble or water-dispersible urethane-modified polyester resin is preferred. It is preferable that the urethane-modified polyester resin include at least one structural unit derived from a hydroxyl group-containing polyester resin (polyester polyol) and at least one structural unit derived from an organic polyisocyanate.

Furthermore, the hydroxyl group-containing polyester resin is a resin formed by an esterification reaction or transesterification reaction between at least one polybasic acid component and at least one polyhydric alcohol component.

A preferred polyurethane resin to be included in the invention is a polyurethane resin obtainable by reacting a polyester polyol, a polyether diol, a polyol containing an anionic group and a polyisocyanate. A particular preferred polyurethane resin is a polyurethane resin obtainable by reacting a polyester polyol, a polyether diol, a polyol containing an anionic group and a polyisocyanate, and wherein the polyester polyol is obtained by reacting an aromatic polycarboxylic acid and a polyol.

The polyurethane emulsion is a polyurethane dispersion that contains an emulsifier in an aqueous dispersion. It can be made by external emulsification method.

The polyurethane emulsion preferably has a particle size of >0.1 μm, and its appearance is preferably white and cloudy. Since the polyurethane is not easily soluble in water, to disperse the polyurethane into water, strong stirring (higher shear force) and the action of a large amount of emulsifier are required, Most of the products of external emulsified polyurethane emulsion have coarser particle size and the residual of hydrophilic small molecule emulsifier, which will affect the performance of polyurethane film after curing, and now it has been gradually dev eloped in the direction of self-emulsified polyurethane dispersion.

Usually, a polyurethane dispersion in water without emulsifiers are called aqueous polyurethane dispersion, or a polyurethane dispersion liquid, with a particle size of 0.001-0.1 μm and translucent appearance. It can be made by an internal emulsification method or a self-emulsification method. The substance with a salt-forming hydrophilic group reacts with the —NCO group of the prepolymer to produce hydrophilic polyurethane salt, which ca n be directly dispersed in water by stirring to obtain a translucent dispersion without adding emulsifier. According to the different hydrophilic groups introduced i n the polyurethane molecule, it can be divided into anionic, cationic and nonionic types. In the film-forming process, water is gradually excluded, and its molecular chains and ionic groups are arranged in a regular pattern, and not only electrostatic effects and hydrogen bonding forces exist, but also cross-linking reactions occur between molecules to form a network structure. Since the re is no emulsifier, these particles are not sensitive to mechanical stirring, heating or dilution, and are resistant to electrolytes; the resulting film is firm and elastic, with strong adhesion.

In a preferred embodiment of the present invention, the aqueous polyurethane dispersion is selected from a self-emulsified aqueous polyurethane dispersion, a aqueous polyurethane emulsion that containing an emulsifier, and a combination thereof, preferably a self-emulsified aqueous polyurethane dispersion.

A suitable polyurethane prepolymer containing isocyanate (—CO) groups used on the polyurethane dispersion is especially obtained from the reaction of at least one polyol with a super stoichiometric amount of at least o ne isocyanate. The reaction is preferably conducted with exclusion of moisture at a temperature in the range from 50 to 160° C., optionally in the presence of suitable catalysts. The NCO/OH ratio is preferably in the range from 1.3/1 to 5/1, preferably 1.5/1 to 4/1, especially 1.8/1 to 3/1. The isocyanate remaining in the reaction mixture after the conversion of the OH groups, especially monomeric diisocyanate, can be removed, especially by means of distillation, which is preferable in the case of a high NCO/OH ratio. The polyurethane prepolymer obtained prefer ably has a content of free isocyanate groups in the range from 1% to 10% by weight, especially 1.5% to 6% by weight.

A suitable polycyanate is especially a commercially available polycyanate, especially—aromatic di- or triisocyanates, preferably diphenylmethane 4, 4′- or 2, 4 or 2, 2′-diisocyanate or any mixtures of these isomers (MDI), tolylene 2, 4- or 2, 6-diisocyanate or any mixtures of these isomers (TDI), mixtures of MDI and MDI homologs (polymeric MDI or PMDI), phenylene 1, 3- or 1, 4-diisocyanate, 2, 3, 5, 6-tetramethyl-1, 4-diisocyanatobenzene, naphthalene 1, 5-diisocyanate (NDI), 3, 3′-dimethyl-4, 4′-diisocyanatodiphenyl (TODI), dianisidine diisocyanate (DADI), tris (4-isocyanatophenyl) methane or tris (4-isocyanatophenyl) thiophosphate; Preferably MDI or TDI; —aliphatic, cycloaliphatic or arylaliphatic di- or triisocyanates, preferably tetramethylene 1, 4-diisocyanate, 2-methylpentamethylene 1, 5-diisocyanate, hexamethylene 1, 6-diisocyanate (HDI), 2, 2, 4- and/or 2, 4, 4-trimethylhexamethylene 1, 6-diisocyanate (TMDI), decamethylene 1, 10-diisocyanate, dodecarnethylene 1, 12-diisocyanate, lysine diisocyanate or lysine ester diisocyanate, cyclohexane 1, 3- or 1, 4-diisocyanate, 1-methyl-2, 4- and/or -2, 6-diisocyanatocyclohexane (H6TDI), 1-isocyanato-3, 3, 5-trimethyl-5-isocyanatomethylcyclohexane (IPDI), perhydrodiphenylmethane 2, 4′- and/or 4, 4′-disocyanate (H12MDI), 1, 3- or 1, 4-bis(isocyanatomethyl) cyclohexane, m- or p-xylylene diisocyanate, tetramethylxylylene 1, 3- or 1, 4-diisocyanate, 1, 3, 5-tris (isocyanatomethyl) benzene, bis(1-isocyanato-1-methylethyl) naphthalene, dimer or trimer fatty acid isocyanates, such as, especially, 3, 6-bis (9-isocyanatononyl) -4, 5-di (1-heptenyl) cyclohexene (dimeryl disocyanate); preferably H12MDI or HDI or IPD I; —oligomers or derivatives of the di- or triisocyanates mentioned, especially derived from HDI, IPDI, MDI or TDI, especially oligomers containing uretdione or isocyanurate or iminooxadiazinedione groups or various groups among these; or di- or polyfunctional derivatives containing ester or urea or urethane or biuret or allophanate or carbodiimide or uretonimine or oxadiazinetrione groups or various groups among these. In practice, polycyanates of this kind are typically mixtures of substances having different degrees of oligomerization and/or chemical structures. They especially have an average NCO functionality of 2.1 to 4.0.

Preferred polycyanates are aliphatic, cycloaliphatic or aromatic diisocyanates, especially HDI, TMDI, cyclohexane 1, 3- or 1, 4-diisocyanate, IPDI, H12MDI, 1, 3- or 1, 4-bis(isocyanatomethyl) cyclohexane, XDI, TDI, MDI, phenylene 1, 3- or 1, 4-diisocyanate or naphthalene 1, 5-diisocyanate (NDI) A particularly preferred polycyanate is HDI, IPDI, H12MDI, TDI, MDI or a form o f MDI which is liquid at room temperature, especially HDI, IPDI, TDI or MDI.

A form of MDI which is liquid at room temperature is either 4, 4′-MDI liquefied by partial chemical modification—especially carbodiimidization or uretonimine formation or adduct formation with polyols—or it is a mixture of 4, 4′-MDI with other MDI isomers (2, 4′-MDI and/or 2, 2′-MDI), and/or with MDI oligomers and/or MDI homologs (PMDI), that has been brought about selectively by blending or results from the production process.

Suitable polyols are commercial polyols or mixtures thereof, especially
Polyether polyols, especially polyoxyalkylenediols and/or polyoxyalkylenetriols, especially polymerization products of ethylene oxide or 1, 2-propylene oxide or 1, 2- or 2, 3-butylene oxide or oxetane or tetrahydrofuran or mixtures thereof, where these may be polymerized with the aid of a starter molecule having two or more active hydrogen atoms, especially a starter molecule such as water, ammonia or a compound having multiple OH or NH groups, such as, for example, ethane-1, 2-diol, propane-1, 2- or -1, 3-diol, neopentyl glycol, diethylene glycol, triethylene glycol, the isomeric dipropyl ene glycols or tripropylene glycols, the isomeric butanediols, pentanediols, hexanediols, heptanediols, octanediols, nonanediols, decanediols, undecanediols, cyclo hexane-1, 3- or -1, 4-dimethanol, bisphenol A, hydrogenated bisphenol A, 1, 1, 1-trimethylolethane, 1, 1, 1-trimethylolpropane, glycerol or aniline, or mixtures of the abovementioned compounds. Likewise suitable are polyether polyols with polymer particles dispersed t herein, especially those with styrene/acrylonitrile (SAN) particles or polyurea or polyhydrazodicarbonamide (PHD) particles. Preferred polyether polyols are polyoxypropylene diols or polyoxypropylene triols, or what are called ethylene oxide-terminated (EO-endcapped) polyoxypropylene diols or triols. The latter are mixed polyoxyethylene/polyoxypropylene polyols which are especially obtained in that polyoxypropylene diols or triols, on conclusion of the polypropoxylation reaction, are further alkoxylated with ethylene oxide and thereby eventually have primary hydroxyl groups. Preferred polyether polyols have a degree of unsaturation of less than 0.02 meq/g, especially less than 0.01 meq/g.
Polyester polyols, also called oligoesterols, prepared by known processes, especially the polycondensation of hydroxycarboxylic acids or lactones or the polycondensation of aliphatic and/or aromatic polycarboxylic acids with di- or polyhydric alcohols. Preference is given to polyester diols from the reaction of dihydric alcohols, such as, especially, 1, 2-ethanediol, diethylene glycol, 1, 2-propanediol, dipropylene glycol, 1, 4-butanediol, 1, 5-pentanediol, 1, 6-hexanediol, neopentyl glycol, glycerol, 1, 1, 1-trimethylolpropane or mixtures of the abovementioned alcohols; with organic dicarboxylic acids or the anhydrides or esters thereof, such as, especially, succinic acid, glutaric acid, adipic acid, suberic acid, sebacic acid, dodecanedicarboxylic acid, maleic acid, fumaric acid, phthalic acid, isophthalic acid, terephthalic acid or hexahydrophthalic acid or mixtures of the abovementioned acids, or polyester polyols from lactones, such as, especially, ε-caprolactone. Particular preference is given to polyester polyols from adipic acid or sebacic acid or dodecanedicarboxylic acid and hexanediol or neopentyl glycol. Suitable commercially available aqueous polyurethane dispersions include Bayhydrol UH 2864 (from Covestro), Archsol® 8355 (from WANHUA), Alberdingk® U 400 N (from Alberdingk Boley). Some other examples of suitable polyurethane dispersions are NEOREZ R-989, NEOREZ R-2005, and NEOREZ R-4000 (DSM NeoResins); BAYHYDROL UH 2606, BAYHYDROL UH XP 2719, BAYHYDROL UH XP 2648, and BAYHYDROL UA XP 2631 (Covestro); DAOTAN VTW 1262/35WA, DAOTAN VTW 1265/36WA, DAOTAN VTW 1267/36WA, DAOTAN VTW 6421/42WA, DAOTAN VTW 6462/36WA (Allnex); and SANCURE 2715, SANCURE 20041, SANCURE 2725 (Lubrizol Corporation), for example, or a combination of two or more of the above.

### Acrylic Emulsions

Acrylic based resins include polymers of acrylic monomers, polymers of methacrylic monomers, and copolymers of the aforementioned monomers with other monomers. These resins are present as a suspension of particles having an average diameter of about 30 nm to about 300 nm. The acrylic latex polymer is formed from acrylic monomers or methacrylic monomer residues. Examples of monomers of the acrylic latex polymer include, by way of illustration, acrylic monomers, such as, for example, acrylate esters, acrylamides, and acrylic acids, and methacrylic monomers, such as, for example, methacrylate esters, methacrylamides, and methacrylic acids. The acrylic latex polymer may be a homopolymer or copolymer of an acrylic monomer and another monomer such as, for example, a vinyl aromatic monomer including, but not limited to, styrene, styrene butadiene, p-chloromethylstyrene, divinyl benzene, vinyl naphthalene and divinylnaphthalene.

The aqueous acrylic polymer dispersion comprises at least one acrylic polymer. The term “acrylic polymer” refers in the present document to homopolymers, copolymers and higher inter-polymers of an acrylic monomer with one or more further acrylic monomers and/or with one or more other ethylenically unsaturated monomers. The term “acrylic monomer” refers in the present document to esters of (meth) acrylic acid, (meth) acrylic acid or derivatives thereof, for example, amides of (meth) acrylic acid or nitriles of (meth) acrylic acid. Preferably, the acrylic polymer contains at least 30% by weight, more preferably at least 40% by weight of acrylic monomers.

Particularly suitable acrylic polymers consist for the most part of (meth) acrylates of alcohols containing from 1 to 24 carbon atoms ((meth) acrylic acid ester monomers). There are preferably more than 25% by weight of these basic monomer building blocks in the acrylic polymer. Further monomer building blocks include, for example, vinyl esters and allyl esters of carboxylic acids containing from 1 to 20 carbon atoms, vinyl ethers of alcohols containing from 1 to 8 carbon atoms, vinyl aromatic compounds, in particular styrene, vinyl halides, non-aromatic hydrocarbons containing from 2 to 8 carbon atoms and at least one olefinic double bond, a and β-unsaturated mono- or di-carboxylic acids containing from 3 to 6 carbon atoms, and derivatives thereof (especially amides, esters and salts). Monomers containing silane-groups can also be present in the acrylic polymers.

Preferably, the acrylic polymer has a number average molecular weight (Mn) in the range of 5,000-200,000 g/mol, preferably 25,000-200,000 g/mol, most preferably 50,000-200,000 g/mol and/or a weight average molecular weight (Mw) in the range of 50,000-800,000 g/mol, preferably 100,000-800,000 g/mol, most preferably 150,000-800,000 g/mol.

Suitable aqueous acrylic polymer dispersion and preparation method thereof are described, for example in EP 0490191 A2, DE 19801892 A1, and in EP 0620243, Suitable commercially available aqueous acrylic polymer dispersions include Primal(R) (from Dow Chemical), Arconal(R) (from BASF), Airflex(R) (from APP), Mowilith(R) (from Celanese), Rhoplex(R) (from Dow Chemical), Plextol(R) (from Synthomer), and Vinnapas(R) (from Wacker), The aqueous acrylic polymer dispersion can comprise two or more different acrylic polymers having different glass transition temperatures and different monomer compositions. The aqueous acrylic polymer dispersion comprising two or more different acrylic polymers can be prepared by mixing commercially available acrylic polymer dispersions, such as those described above.

The acrylic and polyurethane components is supplied to the compositions of the disclosure as separate, individual components.

In an exemplary embodiment, the acrylic and polyurethane components are provided in the form of a combined, single product, which is a product based on an aqueous emulsion of a pure acrylic polymer, i.e., non-styrenic, thermoplastic, which has been combined with an aliphatic polyurethane polymer in aqueous dispersion/solution. This combined product can contain different proportions of the acrylic and polyurethane components, namely: in the exemplary embodiments the concentration of the polyurethane dispersion component is from 5 to 85% by weight of the total weight of the combined product, for example, from 7 to 75%, for example, from 10 to 50%, for example, from 10 to 30% by weight of the total weight of the combined product; and in the exemplary embodiments the concentration of the acrylic emulsion component is from 5 to 85% by weight of the total weight of the combined product, for example, from 7 to 75%, for example, from 10 to 50%, for example, from 10 to 30% by weight of the total weight of the combined product.

In one embodiment, the combined acrylic-polyurethane product is supplied to the final compositions of the disclosure at an exemplary concentration between 10 and 50% by weight of combined product of the total weight of the final composition; for example, between 20 and 50% by weight, for example, between 30 and 40%, for example, between 35 and 40%, for example, about 37% of the total weight of the final composition.

The combined acrylic-polyurethane product can have a solid content of between 30 and 70% by weight, for example, between 40 and 50% by weight, in view of the weight of the combined acrylic-polyurethane product. It can be an emulsion or dispersion.

In one embodiment, the PUD could be added into acrylics at a ratio up to 100%, which means 50/50 of acrylics and PUD. Stated another way, the PUD concentration by weight in the hybrid blend of PUD and acrylic emulsion is any one of the following numbers or a number within a range defined by any two numbers below, including the endpoints of such range, by percentage weight: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50.

Stated another way, the acrylic emulsion concentration by weight in the hybrid blend of PUD and acrylic emulsion is any one of the following numbers or a number within a range defined by any two numbers below, including the endpoints of such range, by percentage weight: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50.

In one embodiment, the PUD concentration by weight is 25%, and the preferred range 10-30%.

By addition of PUD, the compositions of the present invention are in compliance of the ASTM D7281 for waterproofing.

The rest of the composition up to 100% can be optionally completed with one or more of the following additives: rheological additives, preservatives, bactericidal agents, de-airing agents, water repellant agents, filler wetting agents, fillers and pigments.

In an exemplary embodiment, in the absence of fillers which form silicate sheets (phyllosilicates) or chains (inosilicate) such as Mica, Muscovite, Wollastonite or Sericite, an excellent hydrothermal and UV stability of the coating can be observed. In an exemplary embodiment, in the absence of phosphates, excellent adhesion properties, for example, on concrete, can be obtained. An exemplary filler is calcium carbonate, for example, ground calcium carbonate. This can allow the formulation of coatings which are cheap and nevertheless show high performance.

To produce exemplary compositions, the indicated starting materials are added step-wise and are mixed in a suitable mixer, obtaining a one component (single pack) product which once applied forms a continuous and seamless membrane with a series of properties making it suitable for waterproofing newly constructed roofs or for restoration.

Exemplary benefits include, for example, high resistance to UV radiation, without yellowing; it maintains its properties in severe conditions (hot and cold); high elasticity, able to bridge cracks; one component system (single pack); it does not contain organic solvents; once cured, it forms a completely continuous seamless membrane; permeable to water vapor.

It has good adherence on a wide range of substrates after suitable treatment thereof including, for example, metal, concrete, wood and ceramic supports. In the case of concrete, the latter can have sufficient compressive strength and adherence greater than 0.8 N/mm² (according to EN 1504-2).

The compositions of the disclosure can be applied with ambient temperatures, for example, between 8 and 35° C. and maximum ambient humidity of 80% and on concretes with humidity less than 8%. They can be applied by means of a roller, brush, and trowel or by spraying. They can be applied in two phases, for example, applying the second layer once the first one is dry; the first layer will in turn have a primer function. If considered necessary according to the characteristics of the work, the system can be reinforced in its entirety or simply in individual points by incorporating a polyester mesh (such as Silva Fleece 120).

The thicknesses of the final system can range between 0.5-2.5 mm depending on the requirements of the roof.

An exemplary aspect is a method for covering a roof, facade, floor, or vertical facing with the composition disclosed above comprising the following steps:
a) stirring the composition by means of mechanical stirring until achieving complete homogeneity thereof;
b) applying the composition resulting from the previous step a) on the roof, facade, floor or vertical facing by means of a roller, brush, trowel or by spraying. In an exemplary embodiment of the disclosure said method furthermore comprises step c):
c) applying the composition resulting from the previous step a) on dry layer obtained by step b) by means of a roller, brush, trowel or by spraying.

In one embodiment, pH is used to stabilize the sample. In another sample viscosity is used to stabilize the sample. In one embodiment, the prepared sample is covered in a contained with a nitrogen blanket.

The above disclosed aqueous composition can be used as a coating for roofs, facades, floors or vertical facings.

An exemplary aspect is a roof, facade, floor or vertical facing comprising the composition which is disclosed above.

### EXPERIMENTAL

Four experimental samples, E1, E2, E3, and E4 of the compositions of the present invention were prepared and tested versus four control samples, C1, C2, C3, and C4. The results of E1 compared to C₁-C₄ are given in Table 1. The results of E2 compared to C1-C4 are given in Table 2. The results of E3 compared to C1-C4 are given in Table 3.

Control sample C1 is the Lanco Coolguard™ Roof RC3700 acrylic urethane. It is 100% acrylic urethane insulating roof membrane. The COOLGUARD™ Roof is a powerful, high performance roof sealer, made from a thick and single component acrylic urethane that is 100% elastomeric. Note, the experimental samples used herein are not single component.

Control C2 is Henry(R) 587 Dura-Brite™ is 100% acrylic from Henry Co., Kimberton, PA.

Control C3 is Henry(R) 687 Enviro-White™ is 100% acrylic from Henry Co., Kimberton, PA.

Control C4, on the other hand, is the Henry(R) 887 Tropic-Cool™, which is a 100% silicone coating, also from the Henry Co., Kimberton PA.

The control formulations are provided in the Tables 1-3.

Bayhydrol® UH 2864 is an anionic aliphatic polyurethane dispersion from Covestro, Leverkusen, Germany. Hauthane L-2357 is a branched, aliphatic, co-solvent free, polyether-based, polyurethane dispersion from C. L. Hauthaway & Sons Corporation, 638 Summer Street Lynn, MA 01905-2092.

TABLE 1

| | Exp. E1 | | Exp. E3 | Exp. E4 |
|---|---|---|---|---|
| | HE587/PUD | Exp. E2 | HE587/PUD | HE587/PUD |
| | Blend MP979 | MP979 | Blend | Blend |
| | (Hauthane | (Hauthane | (Covestro | (Covestro |
| Content/Blend | L-2357) | L-2357) | UH-2864) | UH-2864) |
| Acrylics Emulsion | 35 | 35 | 35 | 35 |
| (Dow EC2100) | | | | |
| PUD Emulsion | 10 | 10 | | |
| (Hauthane L-2357) | | | | |
| PUD Emulsion | | | 10 | 10 |
| (Covestro UH- | | | | |
| 2864) | | | | |
| Pigment (TiO₂) | 7 | 7 | 7 | 7 |
| Filler (CaCO₃) | 30 | 30 | 30 | 30 |
| Water | 13 | 13 | 13 | 13 |
| Misc. Ingredients | 5 | 5 | 5 | 5 |
| (processing aid, | | | | |
| biocide, etc.) | | | | |

As can be seen below, the experimental samples E1-E3 showed the following advantages:
Passed ponding water test ASTM D7281;
Much better flexibility/elongation;
Better weatherability/durability;
Better adhesion to EPDM and TPO; and
Similar DPUR performance.

### I. Ponding Water Test ASTM D7281

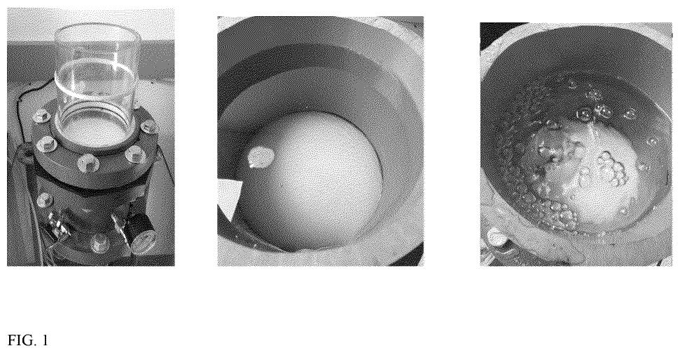

In FIG. 1 is shown the ASTM 7281 test apparatus. The second picture is the experimental sample E1, which showed no leakage. In the third picture is shown the control C1, which failed and was leaking.

### II. Better Weatherability—QSUN 1000 Hours

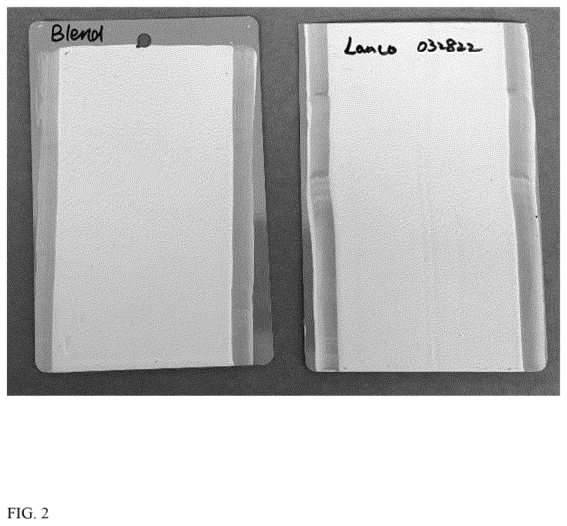

As shown in FIG. 2, the sample on left is the experimental sample comprising the blend of PUD and acrylic emulsion. The sample on the right is the control sample C1. This was when the samples were freshly applied.

After QSUN 1000 hours, the samples were visually investigated. The control sample C1 showed significant yellowing. The experimental sample E1, on the left, showed some yellowing but appeared much better in terms of yellowing than the control sample C1.

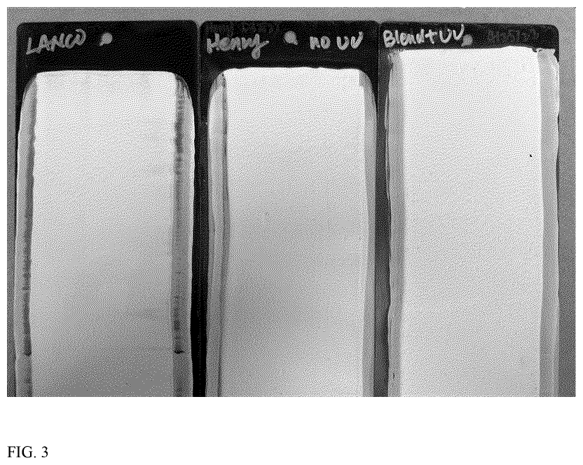

The experimental sample E1 with a UV stabilizer showed a significant improvement as can be seen in FIG. 3. The sample on the left is C1. The one in center is E1 and the one on the right is E1 plus a UV stabilizer.

In one embodiment, the prepared sample is covered in a contained with a nitrogen blanket.

### Better Flexibility/Elongation

| Fresh Samples | C1 | E1 |
|---|---|---|
| Tensile Stress (PSI) | 355 | 268 |
| Elongation (%) | 52 | 174 |

| After QSUN 1000 hrs | C1 | E1 |
|---|---|---|
| Tensile Stress (PSI) | 394 | 346 |
| Elongation (%) | 73 | 189 |

ASTM D6083 Requirement (Before and After QSUN 1000 Hours)

| Tensile Stress | >200 psi |
|---|---|
| Elongation | >100% |

It was found that the control sample C1 was much more brittle and failed to meet the ASTM D6083 standard.

### Better Adhesion on TPO

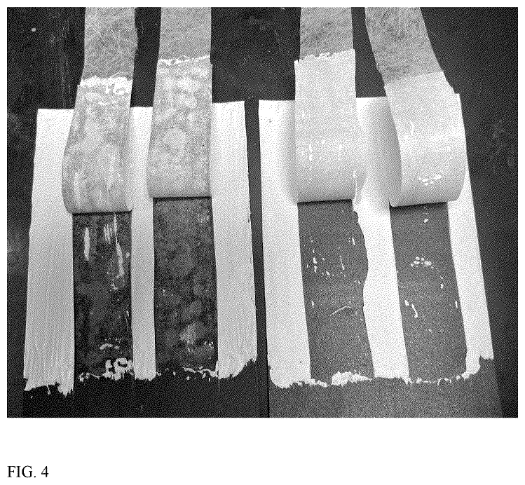

As shown in FIG. 4, the sample on the left is the experimental sample E1 that showed partial cohesive failure at 2.0 pli. The sample on the right is the control sample C1, which showed complete adhesive failure at 1.1 pli.

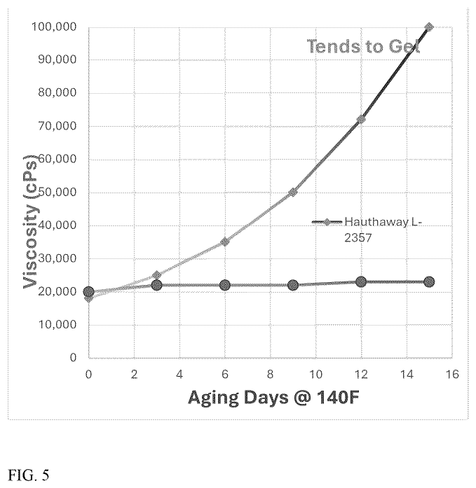

As shown in FIG. 5, the chart gives viscosity as function of aging for the L-2357 PU which tends to gel and the present composition, which is a BLEND (TWO COMPONENT).

### Application of Acrylic Polyurethane White Elastomeric Roof Coating

The table below gives physical properties of a sample of the Acrylic-PUD roof coating.

### Typical Physical Properties

| | | | |
|---|---|---|---|
| Appearance | Bright white | Low Temp | Pass 0º F. |
| | liquid | Flexibility | @ ½ inch |
| | | (Initial) | bend |
| | | (ASTM D522) | |
| Solids by Weight | 60.2% | Low Temp | Pass 0º F. |
| (ASTM D1644) | minimum | Flexibility (After | @ ½ inch |
| | | 1,000 hours | bend |
| | | aging) | |
| | | (ASTM D522) | |
| Solids by Volume | 45.6% | Solar Reflectance | 0.83 initial |
| | minimum | per CRRC | |
| | | (ASTM C1549) | |
| VOC | <50 g/l | Thermal | 0.91 initial |
| | | Emittance per | |
| | | CRRC | |
| | | (ASTM C1371) | |
| Weight per Gallon | 10.97 lbs | Solar Reflectance | 104 initial+ |
| (ASTM D1475) | | Index (SRI) per | |
| | | CRRC | |
| | | (ASTM E1980) | |
| Brookfield | 20,000 cPs, | Water Absorption | 12% |
| Viscosity | 6D/20 | (ASTM D471) | maximum |
| (ASTM D2196) | rpm | | |
| Tensile Strength | 250 psi | Water Vapor | 20 perms |
| Film (Initial) | minimum | Permeance | maximum |
| (ASTM D2370) | | (ASTM D96) | |
| Elongation | 150% | Application | 50º F. and |
| (Initial) | minimum | Temperature | rising |
| (ASTM D2370) | | (Ambient) | |
| Elongation (After | 100% | Ponding Water | Pass |
| 1,000 hours | minimum | Resistance | |
| aging) | | (ASTM D7281) | |
| (ASTM D2370) | | | |
| | | DPUR SR Retain | 81.3% |
| | | (% after Dirt | |
| | | Staining, internal | |
| | | method) | |

The exemplary roof coating is an acrylic polyurethane hybrid formula offering better film strength, better weather protection, solar reflectivity, better durability, and longevity versus standard acrylic reflective roof coatings. It is bright white with excellent hiding power. It reflects >760/of sun's heat and UV rays after 3 years; saves energy and prolongs roof life. Further it resists dirt pick-up 810/or greater. It can be used for recoating roofs previously coated with asphalt emulsion, acrylic or aluminum coatings, aged asphalt roofs, including Built-Up Roofing (BUR) and Modified Bitumen (MB), metal roofs, and concrete roofs.

### Application

### Cleaning

Before coating the roof, a pressure-washer or high-pressure nozzle and water-hose is used to wash the roof with a non-filming detergent such as trisodium phosphate (TSP) or TSP substitute. Appropriate pressure is used and precaution is taken not to inject water into the roof substrate. In areas with stubborn dirt, grease, or other contaminants, a stiff bristle brush or broom is used to scrub the area clean with additional water and non-filming detergent. Also algae or moss are treated. For example, the most effective method of cleaning algae and moss from a roof is with a 50:50 mix of laundry-strength liquid chlorine bleach and water. It is applied with a sprayer and the solution is allowed to dwell on the roof surface for 15 to 20 minutes, followed by rinsing thoroughly with low-pressure water. Because extended dwell times may be necessary, however, it is best to avoid letting the solution dry completely as this may prevent complete rinsing. One should take proper precautions to protect landscaping and surrounding areas from the chlorine bleach solution. One should also use appropriate personal protective equipment when working with chlorine bleach. In severe cases, it may take more than one bleach treatment to kill all of the moss. One may also give the roof a final rinse to ensure it is free of all detergent or anything else that could affect adhesion. The roof is allowed to dry completely before application. The remaining dust, dirt, debris, and foreign material that may prevent proper adhesion can be cleared using a leaf-blower or a broom.

### Preparation

The area to be coated is carefully inspected i including around pipes, chimneys, equipment, roof edges, and walls. All cracks, breaks, splits, and holes are repaired by embedding a repair-fabric between two heavy coats of roofing sealant applied over and at least 2″ beyond repair. The fasteners on metal roofs are tightened. Also, fasteners and seams are sealed with roofing sealant. One should allow all repairs to form a skin and set up from 2-24 hours, depending on depth of the fill and weather conditions before coating. One should also ensure all drains are clean and clear, and cut back any vegetation that is growing that my cause debris to fall on the roof and clog drains in the future. On metal roofs, rust can be removed by wire-brushing.

### Application of the Coating

The coating is mixed thoroughly. It is generally preferred to apply the coating on a sunny day when roof surface is warm to the touch. Surface may be dry or slightly damp, but not wet. If the roof surface is too hot to touch >140° F. (>60° C.), for example, it should be considered as too hot to coat. The coating is applied with a heavy-duty sprayer or deep-pile paint-roller with wood handle and metal threads, keeping strokes in one direction.

### Recoating

The second coat is applied when the first is dry, preferably on the same day. It is preferred to allows drying fully between coats. For large roofs, two coats can be applied to one section per day. It is also preferred to apply the second coat at right angles to first coat. The coating should be completed such that there are two or more hours are available for drying before dark.

TABLE 1.1

| Key Critical | Test | | | | | | | | | | Experiment | |
|---|---|---|---|---|---|---|---|---|---|---|---|---|
| Property | Method | Requirement | Control 1 | | Control 2 | | Control 3 | | Control 4 | | E1 | |
| VOC | calc | <50 g/L | <50 g/L | | 46.2 | g/I | 45.9 | g/l | <50 | g/L | <50 | g/L |
| | | | (not | | | | | | | | | |
| | | | tested/ | | | | | | | | | |
| | | | verified) | | | | | | | | | |
| Weight | Measured | equivalent to | 62.0% | | 60.1% | | 61.2% | | 92.7% | | 59.6% | |
| Solids | | control | | | | | | | | | | |
| Volume | Theoretical | | 46.0% | | 45.2% | | 46.4% | | 92.1% | | 45.2% | |
| Solids | | | | | | | | | | | | |
| DENSITY | Measured | equivalent to | 10.4 | | 11.0 | | 11.1 | | 10.6 | | 10.8 | |
| THEO = | | control | | | | | | | | | | |
| 10.97 | | | | | | | | | | | | |
| (lb/gallon) | | | | | | | | | | | | |
| INITIAL pH | | | 9.3 | | 9.4 | | 9.4 | | NA | | 9.2 | |
| Properties - | | | | | | | | | | | | |
| Fresh | | | | | | | | | | | | |
| Stormer | D562 | | 115- | | 127KU | | 125KU | | 92KU | | 129KU | |
| Viscosity | | | 125KU | | | | | | | | | |
| Brookfield | | | ~15,000 | cPs | 19,000 | cPs | 17,800 | cPs | 8,000 | cPs | 24,200 | cps |
| Viscosity | | | | | | | | | | | | |
| Tensile, 73 F. | D2370 | ASTM | 355 | psi | 193 | psi | 209 | psi | 257 | psi | 268 | psi |
| | | D6083, >200 psi | | | | | | | | | | |
| Elongation, | D2370 | ASTM | 52% | | 316% | | 334% | | 206% | | 174% | |
| 73 F. | | D6083, >100% | | | | | | | | | | |
| Flexibility, 1 | | ASTM D6083, | Pass | | Pass | | Pass | | Pass | | Pass | |
| inch | | Pass | | | | | | | | | | |
| mandrel | | | | | | | | | | | | |
| bend @ 0 F. | | | | | | | | | | | | |
| Solar | C1549 | current CRRC | 84.6% | | 85.0% | | 85.0% | | 90.0% | | 84.3% | |
| Reflectance, | | 84% | | | | | | | | | | |
| initial | | | | | | | | | | | | |
| Thermal | C1549 | current CRRC | 90% | | 90% | | 90% | | 90% | | 90% | |
| Emissivity, | | 91% | | | | | | | | | | |
| initial | | | | | | | | | | | | |
| Properties - | | | | | | | | | | | | |
| after 1000 hr | | | | | | | | | | | | |
| accel | | | | | | | | | | | | |
| weathering | | | | | | | | | | | | |
| Panel | D4798 | ASTM D6083, | Discernible | | No | | No | | No | | No cracking, | |
| Appearance | | No Cracking | yellowing | | Cracking/ | | Cracking/ | | Cracking/ | | checking or | |
| | | | | | checking | | checking | | checking | | yellowing | |
| Solar | C1549 | | | | | | | | | | 83.2% | |
| Reflectance, | | | | | | | | | | | | |
| after QUV | | | | | | | | | | | | |
| 1000 hours | | | | | | | | | | | | |
| Tensile, 73 F. | D2370 | ASTM | 394 | psi | | | | | | | 346 | psi |
| | | D6083, >200 psi | | | | | | | | | | |
| Elongation, | D2370 | ASTM | 73% | | | | | | | | 189% | |
| 73 F. | | D6083, >100% | | | | | | | | | | |
| DPUR (SR | internal | equivalent to | 80.0% | | 77.5% | | 79.2% | | 80.2% | | 81.0% | |
| retain % | | control | | | | | | | | | | |
| after Dirt | | | | | | | | | | | | |
| Staining) | | | | | | | | | | | | |
| Rain-ready | internal | equivalent to | 45-60 | min | 45-60 | min | 45-60 | min | 15-30 | min | 45-60 | min |
| | | control | | | | | | | | | | |
| Permeance | D1653-13 | ASTM | 12.0 | | 9.9 | | 9.5 | | 4.6 | | 8.9 | |
| | | D6083, <50 | | | | | | | | | | |
| | | perms | | | | | | | | | | |
| Water | D471 | TDS, <20% | 16.6% | | 13.8% | | 12.6% | | <0.01% | | 14.3% | |
| Absorption | | | | | | | | | | | | |
| Ponding | ASTM | NA | Fail | | Not Passing | | Not Passing | | Pass | | Pass | |
| Water | D7281 | | | | | | | | | | | |
| Resistance | | | | | | | | | | | | |
| Dry time, | D1640 | TD5, <4 hrs | 3-4 | hours | 3-4 | hours | 3-4 | hours | 2-3 | hours | 3-4 | hours |
| @25 mil wet, | | | | | | | | | | | | |
| RT, 50% | | | | | | | | | | | | |
| RH | | | | | | | | | | | | |
| Adhesion, | D903 | | | | | | | | | | | |
| DRY, lbf | | | | | | | | | | | | |

| | | | | | | | |
|---|---|---|---|---|---|---|---|
| 585 | | equivalent to | 4.46(C) | 8.20(C) | 7.10(C) | 3.23(C) | 7.02(C) |
| Granulated | | control | | | | | |
| Cap Sheet | | | | | | | |
| SBS Smooth | | equivalent to | 4.08(C) | 8.00(C) | 8.3(C) | 3.6(C) | 8.00(C) |
| Cap Sheet | | control | | | | | |
| Aluminum | | equivalent to | 5.05(C) | 8.96(C) | 6.24(C) | 5.12(C) | 8.50(C) |
| | | control | | | | | |
| Concrete | | equivalent to | 5.17(C) | 7.22(C) | 5.1(C) | 4.75(C) | 8.05(C) |
| | | control | | | | | |
| EPDM | | equivalent to | 1.40(A) | 1.85(A) | 0.82(A) | 0.89(A) | 2.65(A) |
| | | control | | | | | |
| TPO | | equivalent to | 1.14(A) | 1.02(A) | 0.63(A) | 0.21(A) | 2.00(A) |
| | | control | | | | | |
| Adhesion, | D903 | | | | | | |
| WET, lbf | | | | | | | |
| 585 | | equivalent to | 2.15(A) | 3.83(A) | 3.83(A) | 2.12(A) | 3.20(C) |
| Granulated | | control | | | | | |
| Cap Sheet | | | | | | | |
| SBS Sanded | | equivalent to | 0.50(A) | 0.71(( ) | 0.81(C) | 0.96(C) | 0.70(A) |
| Cap Sheet | | control | | | | | |
| Aluminum | | equivalent to | 1.75(C) | 0.35(A) | 0.55(A) | 2.35(A) | 1.50(C) |
| | | control | | | | | |
| Concrete | | equivalent to | 1.93(C) | 4.20(( ) | 3.30(( ) | 2.30(C) | 3.25(C) |
| | | control | | | | | |
| EPDM | | equivalent to | 0.60(A) | 1.00(A) | 0.85(A) | 0.35(A) | 1.42(A) |
| | | control | | | | | |
| TPO | | equivalent to | 0.80(A) | 0.40(A) | 0.25(A) | 0.02(A) | 1.55(A) |
| | | control | | | | | |

TABLE 2

| Key Critical | Test | | | | | | | | | | Experiment | |
|---|---|---|---|---|---|---|---|---|---|---|---|---|
| Property | Method | Requirement | Control 1 | | Control 2 | | Control 3 | | Control 4 | | E2 | |
| VOC | calc | <50 g/L | <50 g/L | | 46.2 | g/I | 45.9 | g/l | <50 | g/L | <50 | g/L |
| | | | (not | | | | | | | | | |
| | | | tested/ | | | | | | | | | |
| | | | verified) | | | | | | | | | |
| Weight | Measured | equivalent to | 62.0% | | 60.1% | | 61.2% | | 92.7% | | 58.5% | |
| Solids | | control | | | | | | | | | | |
| Volume | Theoretical | | 46.0% | | 45.2% | | 46.4% | | 92.1% | | 43.8% | |
| Solids | | | | | | | | | | | | |
| DENSITY | Measured | equivalent to | 10.4 | | 11.0 | | 11.1 | | 10.6 | | 10.8 | |
| THEO = | | control | | | | | | | | | | |
| 10.97 | | | | | | | | | | | | |
| (lb/gallon) | | | | | | | | | | | | |
| INITIAL pH | | | 9.3 | | 9.4 | | 9.4 | | NA | | 9.4 | |
| Properties - | | | | | | | | | | | | |
| Fresh | | | | | | | | | | | | |
| Stormer | D562 | | 115- | | 127KU | | 125KU | | 92KU | | 131KU | |
| Viscosity | | | 125KU | | | | | | | | | |
| Brookfield | | | ~15,000 | cPs | 19,000 | cPs | 17,800 | cPs | 8,000 | cPs | 22,000 | cPs |
| Viscosity | | | | | | | | | | | (Fresh) | |
| Tensile, 73 F. | D2370 | ASTM | 355 | psi | 193 | psi | 209 | psi | 257 | psi | 398 | psi |
| | | D6083, >200 psi | | | | | | | | | | |
| Elongation, | D2370 | ASTM | 52% | | 316% | | 334% | | 206% | | 196% | |
| 73 F. | | D6083, >100% | | | | | | | | | | |
| Flexibility, 1 | | ASTM D6083, | Pass | | Pass | | Pass | | Pass | | Pass | |
| inch | | Pass | | | | | | | | | | |
| mandrel | | | | | | | | | | | | |
| bend @ 0 F. | | | | | | | | | | | | |
| Solar | C1549 | current CRRC | 84.6% | | 85.0% | | 85.0% | | 90.0% | | 85.0% | |
| Reflectance, | | 84% | | | | | | | | | | |
| initial | | | | | | | | | | | | |
| Thermal | C1549 | current CRRC | 90% | | 90% | | 90% | | 90% | | 91% | |
| Emissivity, | | 91% | | | | | | | | | | |
| initial | | | | | | | | | | | | |
| Properties - | | | | | | | | | | | | |
| after 1000 hr | | | | | | | | | | | | |
| accel | | | | | | | | | | | | |
| weathering | | | | | | | | | | | | |
| Panel | D4798 | ASTM D6083, | Discernible | | No | | No | | No | | No cracking, | |
| Appearance | | No Cracking | yellowing | | Cracking/ | | Cracking/ | | Cracking/ | | checking or | |
| | | | | | checking | | checking | | checking | | yellowing | |
| Solar | C1549 | | | | | | | | | | not tested | |
| Reflectance, | | | | | | | | | | | | |
| after QUV | | | | | | | | | | | | |
| 1000 hours | | | | | | | | | | | | |
| Tensile, 73 F. | D2370 | ASTM | 394 | psi | | | | | | | not tested | |
| | | D6083,>200 psi | | | | | | | | | | |
| Elongation, | D2370 | ASTM | 73% | | | | | | | | not tested | |
| 73 F. | | D6083, >100% | | | | | | | | | | |
| DPUR (SR | internal | equivalent to | 80.0% | | 77.5% | | 79.2% | | 80.2% | | 81.2% | |
| retain % | | control | | | | | | | | | | |
| after Dirt | | | | | | | | | | | | |
| Staining) | | | | | | | | | | | | |
| Rain-ready | internal | equivalent to | 45-60 | min | 45-60 | min | 45-60 | min | 15-30 | min | 45 | min |
| | | control | | | | | | | | | | |
| Permeance | D1653-13 | ASTM | 12.0 | | 9.9 | | 9.5 | | 4.6 | | 10.8 | |
| | | D6083, <50 | | | | | | | | | | |
| | | perms | | | | | | | | | | |
| Water | D471 | TDS, <20% | 16.6% | | 13.8% | | 12.6% | | <0.01% | | 10.5% | |
| Absorption | | | | | | | | | | | | |
| Ponding | ASTM | NA | Fail | | Not Passing | | Not Passing | | Pass | | Pass | |
| Water | D7281 | | | | | | | | | | | |
| Resistance | | | | | | | | | | | | |
| Dry time, | D1640 | TD5, <4 hrs | 3-4 | hours | 3-4 | hours | 3-4 | hours | 2-3 | hours | 3-4 | hours |
| @25 mil wet, | | | | | | | | | | | | |
| RT, 50% | | | | | | | | | | | | |
| RH | | | | | | | | | | | | |
| Adhesion, | D903 | | | | | | | | | | | |
| DRY, lbf | | | | | | | | | | | | |

| | | | | | | | |
|---|---|---|---|---|---|---|---|
| 585 | | equivalent to | 4.46(C) | 8.20(C) | 7.10(C) | 3.23(C) | 3.76(C) |
| Granulated | | control | | | | | |
| Cap Sheet | | | | | | | |
| SBS Smooth | | equivalent to | 4.08(C) | 8.00(C) | 8.3(C) | 3.6(C) | 5.21(C) |
| Cap Sheet | | control | | | | | |
| Aluminum | | equivalent to | 5.05(C) | 8.96(C) | 6.24(C) | 5.12(C) | 3.46(A) |
| | | control | | | | | |
| Concrete | | equivalent to | 5.17(C) | 7.22(C) | 5.1(C) | 4.75(C) | 5.94(C) |
| | | control | | | | | |
| EPDM | | equivalent to | 1.40(A) | 1.85(A) | 0.82(A) | 0.89(A) | 2.37(A) |
| | | control | | | | | |
| TPO | | equivalent to | 1.14(A) | 1.02(A) | 0.63(A) | 0.21(A) | no sample |
| | | control | | | | | prepared |
| Adhesion, | D903 | | | | | | |
| WET, lbf | | | | | | | |
| 585 | | equivalent to | 2.15(A) | 3.83(A) | 3.83(A) | 2.12(A) | 2.80(C) |
| Granulated | | control | | | | | |
| Cap Sheet | | | | | | | |
| SBS Sanded | | equivalent to | 0.50(A) | 0.71(( ) | 0.81(C) | 0.96(C) | 0.74(C) |
| Cap Sheet | | control | | | | | |
| Aluminum | | equivalent to | 1.75(C) | 0.35(A) | 0.55(A) | 2.35(A) | peel off |
| | | control | | | | | (repeat) |
| Concrete | | equivalent to | 1.93(C) | 4.20(( ) | 3.30(( ) | 2.30(C) | 4.34(C) |
| | | control | | | | | |
| EPDM | | equivalent to | 0.60(A) | 1.00(A) | 0.85(A) | 0.35(A) | 2.17(A) |
| | | control | | | | | |
| TPO | | equivalent to | 0.80(A) | 0.40(A) | 0.25(A) | 0.02(A) | no sample |
| | | control | | | | | prepared |

TABLE 3

| Key Critical | Test | | | | | | | | | | Experiment | |
|---|---|---|---|---|---|---|---|---|---|---|---|---|
| Property | Method | Requirement | Control 1 | | Control 2 | | Control 3 | | Control 4 | | E3 | |
| VOC | calc | <50 g/L | <50 g/L | | 46.2 | g/I | 45.9 | g/l | <50 | g/L | <50 | g/L |
| | | | (not | | | | | | | | | |
| | | | tested/ | | | | | | | | | |
| | | | verified) | | | | | | | | | |
| Weight | Measured | equivalent to | 62.0% | | 60.1% | | 61.2% | | 92.7% | | 60.2% | |
| Solids | | control | | | | | | | | | | |
| Volume | Theoretical | | 46.0% | | 45.2% | | 46.4% | | 92.1% | | 45.6% | |
| Solids | | | | | | | | | | | | |
| DENSITY | Measured | equivalent to | 10.4 | | 11.0 | | 11.1 | | 10.6 | | 10.8 | |
| THEO = | | control | | | | | | | | | | |
| 10.97 | | | | | | | | | | | | |
| (lb/gallon) | | | | | | | | | | | | |
| INITIAL pH | | | 9.3 | | 9.4 | | 9.4 | | NA | | 9.8 | |
| Properties - | | | | | | | | | | | | |
| Fresh | | | | | | | | | | | | |
| Stormer | D562 | | 115- | | 127KU | | 125KU | | 92KU | | 121KU | |
| Viscosity | | | 125KU | | | | | | | | | |
| Brookfield | | | ~15,000 | cPs | 19,000 | cPs | 17,800 | cPs | 8,000 | cPs | 19,500 | cps |
| Viscosity | | | | | | | | | | | | |
| Tensile, 73 F. | D2370 | ASTM | 355 | psi | 193 | psi | 209 | psi | 257 | psi | 279 | psi |
| | | D6083, >200 psi | | | | | | | | | | |
| Elongation, | D2370 | ASTM | 52% | | 316% | | 334% | | 206% | | 184% | |
| 73 F. | | D6083, >100% | | | | | | | | | | |
| Flexibility, 1 | | ASTM D6083, | Pass | | Pass | | Pass | | Pass | | Pass | |
| inch | | Pass | | | | | | | | | | |
| mandrel | | | | | | | | | | | | |
| bend @ 0 F. | | | | | | | | | | | | |
| Solar | C1549 | current CRRC | 84.6% | | 85.0% | | 85.0% | | 90.0% | | 85.1% | |
| Reflectance, | | 84% | | | | | | | | | | |
| initial | | | | | | | | | | | | |
| Thermal | C1549 | current CRRC | 90% | | 90% | | 90% | | 90% | | 90% | |
| Emissivity, | | 91% | | | | | | | | | | |
| initial | | | | | | | | | | | | |
| Properties - | | | | | | | | | | | | |
| after 1000 hr | | | | | | | | | | | | |
| accel | | | | | | | | | | | | |
| weathering | | | | | | | | | | | | |
| Panel | D4798 | ASTM D6083, | Discernible | | No | | No | | No | | No cracking, | |
| Appearance | | No Cracking | yellowing | | Cracking/ | | Cracking/ | | Cracking/ | | checking or | |
| | | | | | checking | | checking | | checking | | yellowing | |
| Solar | C1549 | | | | | | | | | | not tested | |
| Reflectance, | | | | | | | | | | | | |
| after QUV | | | | | | | | | | | | |
| 1000 hours | | | | | | | | | | | | |
| Tensile, 73 F. | D2370 | ASTM | 394 | psi | | | | | | | not tested | |
| | | D6083, >200 psi | | | | | | | | | | |
| Elongation, | D2370 | ASTM | 73% | | | | | | | | not tested | |
| 73 F. | | D6083, >100% | | | | | | | | | | |
| DPUR (SR | internal | equivalent to | 80.0% | | 77.5% | | 79.2% | | 80.2% | | 81.3% | |
| retain % | | control | | | | | | | | | | |
| after Dirt | | | | | | | | | | | | |
| Staining) | | | | | | | | | | | | |
| Rain-ready | internal | equivalent to | 45-60 | min | 45-60 | min | 45-60 | min | 15-30 | min | 45-60 | min |
| | | control | | | | | | | | | | |
| Permeance | D1653-13 | ASTM | 12.0 | | 9.9 | | 9.5 | | 4.6 | | 12.4 | |
| | | D6083, <50 | | | | | | | | | | |
| | | perms | | | | | | | | | | |
| Water | D471 | TDS, <20% | 16.6% | | 13.8% | | 12.6% | | <0.01% | | 12.3% | |
| Absorption | | | | | | | | | | | | |
| Ponding | ASTM | NA | Fail | | Not Passing | | Not Passing | | Pass | | in progress | |
| Water | D7281 | | | | | | | | | | | |
| Resistance | | | | | | | | | | | | |
| Dry time, | D1640 | TD5, <4 hrs | 3-4 | hours | 3-4 | hours | 3-4 | hours | 2-3 | hours | 3-4 | hours |
| @25 mil wet, | | | | | | | | | | | | |
| RT, 50% | | | | | | | | | | | | |
| RH | | | | | | | | | | | | |
| Adhesion, | D903 | | | | | | | | | | | |
| DRY, lbf | | | | | | | | | | | | |

| | | | | | | | |
|---|---|---|---|---|---|---|---|
| 585 | | equivalent to | 4.46(C) | 8.20(C) | 7.10(C) | 3.23(C) | 7.44(C) |
| Granulated | | control | | | | | |
| Cap Sheet | | | | | | | |
| SBS Smooth | | equivalent to | 4.08(C) | 8.00(C) | 8.3(C) | 3.6(C) | 8.80(C) |
| Cap Sheet | | control | | | | | |
| Aluminum | | equivalent to | 5.05(C) | 8.96(C) | 6.24(C) | 5.12(C) | 9.25(C) |
| | | control | | | | | |
| Concrete | | equivalent to | 5.17(C) | 7.22(C) | 5.1(C) | 4.75(C) | 8.13(A) |
| | | control | | | | | |
| EPDM | | equivalent to | 1.40(A) | 1.85(A) | 0.82(A) | 0.89(A) | 2.70(A) |
| | | control | | | | | |
| TPO | | equivalent to | 1.14(A) | 1.02(A) | 0.63(A) | 0.21(A) | 2.50(A) |
| | | control | | | | | |
| Adhesion, | D903 | | | | | | |
| WET, lbf | | | | | | | |
| 585 | | equivalent to | 2.15(A) | 3.83(A) | 3.83(A) | 2.12(A) | 3.48(C) |
| Granulated | | control | | | | | |
| Cap Sheet | | | | | | | |
| SBS Sanded | | equivalent to | 0.50(A) | 0.71(C) | 0.81(C) | 0.96(C) | 0.52(A) |
| Cap Sheet | | control | | | | | |
| Aluminum | | equivalent to | 1.75(C) | 0.35(A) | 0.55(A) | 2.35(A) | 1.39(C) |
| | | control | | | | | |
| Concrete | | equivalent to | 1.93(C) | 4.20(C) | 3.30(C) | 2.30(C) | 3.73(C) |
| | | control | | | | | |
| EPDM | | equivalent to | 0.60(A) | 1.00(A) | 0.85(A) | 0.35(A) | 2.61(A) |
| | | control | | | | | |
| TPO | | equivalent to | 0.80(A) | 0.40(A) | 0.25(A) | 0.02(A) | 1.11(A) |
| | | control | | | | | |

### Blend Optimization

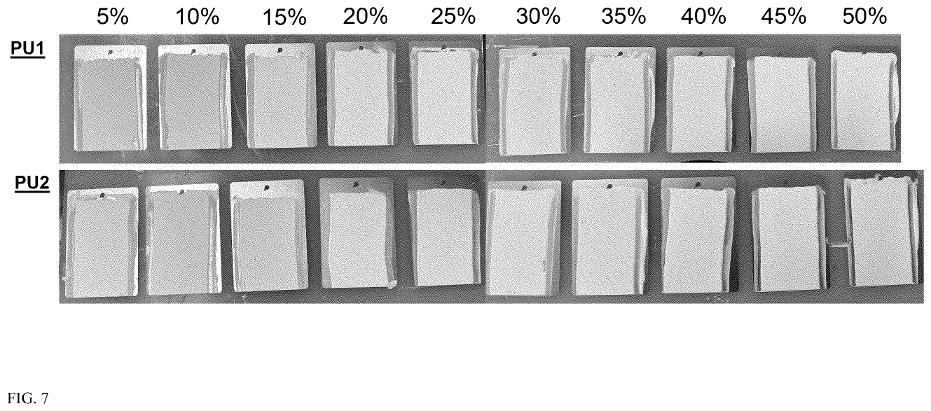

The acrylic emulsion and the polyurethane dispersion were optimized in a series of experiments. The blends were prepared from the HE587 Durabrite® type 1000/acrylic emulsion and the Covestro Bayhydrol® UH-2864 polyurethane dispersion in ratios given in the following table. Many properties including viscosity, pH, solids, contact angle, and 14-day tensile and elongation were measured. The data are also provided in the table. FIG. 7 relates to the corresponding samples prepared. Embodiments of the present invention meet the ASTM D6083 standard as well as providing improved waterproofing, improved mechanical properties, enhanced adhesion to substrates, rain-readiness similar to the acrylic control samples, and similar application profile as the acrylic control samples. The present invention is a low-cost alternative to the high-priced silicone based coatings (Control 4, for example). PU1 relates to the blend that does not include the UV additive. PU2 includes the UV additive. With more PUD, it is more compatible, flexible, and shows UV resistance.

TABLE 4
Relevant Properties for Acrylic/PUD Blends

| | % Blend Acrylic/Polyurethane PU2 | | | | | | | | | | | |
|---|---|---|---|---|---|---|---|---|---|---|---|---|
| | | | | | | | | | | | | PU2 |
| | Control | | | | | | | | | | | (Exp. |
| | C2 | | | | | | | | | | | E2) |
| Properties | 100/0 | 95/5 | 90/10 | 85/15 | 80/20 | 75/25 | 70/30 | 65/35 | 60/40 | 55/45 | 50/50 | 0/100 |
| Brookfield | 33760 | 30480 | 32160 | 30200 | 28600 | 26400 | 26000 | 21320 | 21000 | 19000 | 16920 | 8040 |
| Viscosity | | | | | | | | | | | | |
| (cPs) | | | | | | | | | | | | |
| pH | 10 | 9.5 | 9.5 | 9.4 | 9.3 | 9.3 | 9.2 | 8.8 | 8.7 | 8.6 | 8.6 | 5.02 |
| % Solids | 51 | 60.8 | 59.3 | 57.5 | 58.0 | 55.6 | 55.4 | 53.7 | 52.2 | 52.0 | 51.5 | 51.3 |
| Contact | 50 | 50 | 60 | 70 | 70 | 70 | 70 | 80 | 80 | 80 | 80 | 70 |
| Angle, | | | | | | | | | | | | |
| Degree | | | | | | | | | | | | |
| 14-Day | 199 | 220 | 234 | 262 | 285 | 312 | 294 | 305 | 358 | 348 | 357 | |
| Tensile | | | | | | | | | | | | |
| (psi) | | | | | | | | | | | | |
| 14-Day | 265 | 197 | 175 | 150 | 139 | 90 | 80 | 83 | 68 | 58 | 54 | |
| Elonga- | | | | | | | | | | | | |
| tion % | | | | | | | | | | | | |
| Delta | | 2.74 | 2.6 | 2.76 | 2.74 | 2.78 | 2.77 | 2.81 | 2.76 | 2.84 | 2.8 | |
| E (PU2 or | | | | | | | | | | | | |
| Ex. E2) | | | | | | | | | | | | |
| Delta | | 2.57 | 2.8 | 2.11 | 2.64 | 2.67 | 2.55 | 2.67 | 2.68 | 2.65 | 2.7 | |
| E(PU1 or | | | | | | | | | | | | |
| Exp. E1) | | | | | | | | | | | | |

Table 5 below lists relevant properties of the controls and the PU2 or Exp. E2 material. In the table below, the first column corresponds to key critical property, the second column relates to the test method, the third to the required results compared to the baseline, the fourth to the Control sample 1, the fifth to the Control sample 2, the sixth to the Control sample 4, and the seventh to the experimental blend E2 of the present invention.

TABLE 5

| | VOC | | | | | | | | | |
|---|---|---|---|---|---|---|---|---|---|---|
| | | | <50 g/L | | | | | | | |
| | | | (not tested/ | | | | | | | |
| | calc | <50 g/L | verified) | | 46.2 g/l | | <50 g/L | | <50 g/L | |
| Weight | Measured | equivalent to | 62.0% | | 60.1% | | 92.7% | | 60.2% | |
| Solids | | control | | | | | | | | |
| Volume | Theoretical | | 46.0% | | 45.2% | | 92.1% | | 45.6% | |
| Solids | | | | | | | | | | |
| DENSITY | Measured | equivalent to | 10.4 | | 11.0 | | 10.6 | | 10.8 | |
| THEO = | | control | | | | | | | | |
| 10.97 | | | | | | | | | | |
| (lb/gallon) | | | | | | | | | | |
| INITIAL pH | | | 9.3 | | 9.4 | | NA | | 9.8 | |
| Properties - | | | | | | | | | | |
| Fresh | | | | | | | | | | |
| Stormer | D562 | | 115-125KU | | 127KU | | 92KU | | 121KU | |
| Viscosity | | | | | | | | | | |
| Brookfield | | | ~15,000 | cPs | 19,000 | cPs | 8,000 | cPs | 19,500 | cps |
| Viscosity | | | | | | | | | | |
| Tensile, 73 F. | D2370 | ASTM | 355 | psi | 193 | psi | 257 | psi | 479 | psi |
| | | D6083, >200 psi | | | | | | | | |
| Elongation, | D2370 | ASTM | 52% | | 316% | | 206% | | 184% | |
| 73 F. | | D6083, >100% | | | | | | | | |
| Flexibility, | | ASTM D6083, | Pass | | Pass | | Pass | | Pass | |
| 1 inch | | Pass | | | | | | | | |
| mandrel | | | | | | | | | | |
| bend @ 0 F. | | | | | | | | | | |
| Solar | C1549 | current CRRC | 84.6% | | 85.0% | | 90.0% | | 85.1% | |
| Reflectance, | | 84% | | | | | | | | |
| initial | | | | | | | | | | |
| Thermal | C1549 | current CRRC | 90% | | 90% | | 90% | | 90% | |
| Emissivity, | | 91% | | | | | | | | |
| initial | | | | | | | | | | |
| Properties - | | | | | | | | | | |
| after 1000 hr | | | | | | | | | | |
| accel | | | | | | | | | | |
| weathering | | | | | | | | | | |
| Panel | D4798 | ASTM D6083, | Discernible | | No cracking/ | | No cracking/ | | No cracking, | |
| Appearance | | No Cracking | yellowing | | checking | | checking | | checking | |
| | | | | | | | | | or yellowing | |
| Solar | C1549 | | | | | | | | | |
| Reflectance, | | | | | | | | | | |
| after QUV | | | | | | | | | | |
| 1000 hours | | | | | | | | | | |
| Tensile, 73 F. | D2370 | ASTM | 394 | psi | | | | | 484 | psi |
| | | D6083, >200 psi | | | | | | | | |
| Elongation, | D2370 | ASTM | 73% | | | | | | 215% | |
| 73 F. | | D6083, >100% | | | | | | | | |
| DPUR (SR | internal | equivalent to | 80.0% | | 77.5% | | 80.2% | | 81.3% | |
| retain % | | control | | | | | | | | |
| after Dirt | | | | | | | | | | |
| Staining) | | | | | | | | | | |
| Rain-ready | internal | equivalent to | 45-60 | min | 45-60 | min | 15-30 | min | 45-60 | min |
| | | control | | | | | | | | |
| Permeance | D1653-13 | ASTM | 12.0 | | 9.9 | | 4.6 | | 12.4 | |
| | | D6083, <50 | | | | | | | | |
| | | perms | | | | | | | | |
| Water | D471 | TDS, <20% | 16.6% | | 13.8% | | <0.01% | | 12.3% | |
| Absorption | | | | | | | | | | |
| Ponding | ASTM | NA | Fail | | Not Passing | | Pass | | in progress | |
| Water | D7281 | | | | | | | | | |
| Resistance | | | | | | | | | | |
| Dry time, | D1640 | TD5, <4 hrs | 3-4 | hours | 3-4 | hours | 2-3 | hours | 3-4 | hours |
| @25 mil wet, | | | | | | | | | | |

| | | | | | | |
|---|---|---|---|---|---|---|
| RT, 50% RH | | | | | | |
| Adhesion, | D903 | | | | | |
| DRY, lbf | | | | | | |
| 585 Granulated | | equivalent to | 4.46(C) | 8.20(C) | 3.23(C) | 7.44(C) |
| Cap Sheet | | control | | | | |
| SBS Smooth | | equivalent to | 4.08(C) | 8.00(C) | 3.6(C) | 8.80(C) |
| Cap Sheet | | control | | | | |
| Aluminum | | equivalent to | 5.05(C) | 8.96(C) | 5.12(C) | 9.25(C) |
| | | control | | | | |
| Concrete | | equivalent to | 5.17(C) | 7.22(C) | 4.75(C) | 8.13(A) |
| | | control | | | | |
| EPDM | | equivalent to | 1.40(A) | 1.85(A) | 0.89(A) | 2.70(A) |
| | | control | | | | |
| TPO | | equivalent to | 1.14(A) | 1.02(A) | 0.21(A) | 2.50(A) |
| | | control | | | | |
| Adhesion, | D903 | | | | | |
| WET, lbf | | | | | | |
| 585 Granulated | | equivalent to | 2.15(A) | 3.83(A) | 2.12(A) | 3.48(C) |
| Cap Sheet | | control | | | | |
| SBS Sanded | | equivalent to | 0.50(A) | 0.71(( ) | 0.96(C) | 0.52(A) |
| Cap Sheet | | control | | | | |
| Aluminum | | equivalent to | 1.75(C) | 0.35(A) | 2.35(A) | 1.39(C) |
| | | control | | | | |
| Concrete | | equivalent to | 1.93(C) | 4.20(( ) | 2.30(C) | 3.73(C) |
| | | control | | | | |
| EPDM | | equivalent to | 0.60(A) | 1.00(A) | 0.35(A) | 2.61(A) |
| | | control | | | | |
| TPO | | equivalent to | 0.80(A) | 0.40(A) | 0.02(A) | 1.11(A) |
| | | control | | | | |

It is clear that the experimental blend of the present invention shows improved properties on many parameters. Table 6 provides the solar reflectance, thermal emittance, and the SRI (ASTM C1549; ASTM C 1371; and ASTM E 1980) numbers measured or the bend sample before and after soiling (AT D79):

TABLE 6

| | Solar | Thermal | SRI |
|---|---|---|---|
| | Reflectance | Emittance | ASTM E 1980 |
| | ASTM C | ASTM C | low-wind; medium- |
| Sample Id. | 1549 | 1371 | wind; high-wind |
| Before Soiling | 0.836 | 0.91 | 104; 105; 105 |
| After Soiling | 0.764 | 0.91 | 94; 94; 95 |

1. An aqueous composition suitable for coating roofs, facades, floors or vertical facings, comprising:
i) an acrylic polymer emulsion, and
ii) an aqueous polyurethane polymer dispersion.

2. The composition according to claim 1, wherein the acrylic polymer and polyurethane polymer is in the form of a combined product of the acrylic polymer with on the polyurethane polymer, wherein the polyurethane polymer is a polyether-based or polyester-based polyurethane.

3. The composition according to claim 2, wherein in the combined product of at least one acrylic polymer with at least one polyurethane polymer, the polyurethane polymer is in a proportion between 5 and 85% by weight of the weight of the combined product;
wherein in the combined product of at least one acrylic polymer emulsion with at least one polyurethane polymer dispersion, the acrylic polymer emulsion is in a proportion between 5 and 85% by weight of the weight of the combined product:
wherein in the combined product of the acrylic polymer with the polyurethane polymer, the polyurethane polymer is in a proportion between 10 and 50% by weight of the weight of the combined product; and/or
wherein the combined product of the acrylic polymer with the polyurethane polymer is at a concentration between 30 and 40% by weight of the total weight of the composition.

4. (canceled)

5. (canceled)

6. (canceled)

7. The composition according to claim 1, wherein, the polyurethane polymer is in the range of 5% to 25% of the total weight of the aqueous composition.

8. The composition according to claim 1, wherein the acrylic polymer is a thermoplastic, non-styrenic polymer in an external aqueous emulsion.

9. The composition according to claim 1, wherein the polyurethane polymer is an aliphatic polymer in aqueous solution or dispersion.

10. The composition according to claim 1, wherein the water content is between 10 and 40% by weight of the total weight of the composition.

11. The composition according to claim 1, further comprising a UV stabilizer.

12. The composition as according to claim 1, comprising an aqueous PUD in the amount of 10% of the total weight of the aqueous composition.

13. The composition as recited in claim 12, wherein the acrylic emulsion content is about 35% of the total weight of the aqueous composition.

14. The composition as recited in claim 13, wherein said composition comprises at least one of a UV stabilizer, rheological additives, preservatives, bactericidal agents, de-airing agents, water repellant agents, filler wetting agents, fillers and pigments, and combinations thereof.

15. A method for covering a roof, facade, floor or vertical facing with a composition, the method comprising:
a) stirring the composition as recited in claim 1 by mechanical stirring until achieving complete homogeneity thereof, and
b) applying the composition resulting from step a) on a roof, facade, floor, or vertical facing with a roller, brush, trowel or by spraying.

16. The method according to claim 15, further comprising:
c) applying the composition resulting from step a) on a dry layer obtained by step b) by means of a roller, brush, trowel or by spraying.

17. The method according to claim 15, further comprising incorporating a polyester mesh in the entirety of the coating surface or in individual points thereof.

18. A method of applying a composition to a substrate, the method comprising:
a) stirring the composition according to claim 1; and
b) applying the composition resulting from the step a) on a substrate.

19. The method according to claim 18, wherein in step a), the stirring is conducted by mechanical stirring.

20. The method according to claim 18, wherein step a) is effective to achieve complete homogeneity of the stirred composition.

21. The method according to claim 18, wherein in step b), the composition is applied with a roller, brush, trowel or by spraying.

22. A roof, facade, floor or vertical facing, comprising an aqueous composition, wherein the aqueous composition comprises:
i) at least one acrylic polymer,
ii) at least one polyurethane polymer as recited in claim 1.

23. The process of preparing the composition as recited in claim 1, comprising controlling the pH and viscosity to stabilize the composition of PUD and acrylic emulsion.
